(19) United States
(12) Patent Application Publication
(10) Pub. No.: US 2020/0324873 A1
(43) Pub. Date: Oct. 15, 2020

(54) RETRACTABLE FLAPS USED FOR ADJUSTING THE TRAJECTORY OF AIRCRAFT, SPACECRAFT, AND WATERCRAFT RELATED VEHICLES OR PROPELLED/PROJECTILE OBJECTS

(71) Applicant: Taylor DiAnte' Brown, Jackson, MS (US)

(72) Inventor: Taylor DiAnte' Brown, Jackson, MS (US)

(21) Appl. No.: 16/383,653

(22) Filed: Apr. 14, 2019

(51) Int. Cl. B64C 3/54

(52) U.S. Cl. CPC B64C 3/54; B64C 2003/543

(57) ABSTRACT

The retractable flap provides a methodology in reducing drag on multiple types of vehicles and objects. These flaps are utilized the same way as any other flap such as the elevator, rudder, or aileron when it comes to trajectory control or steering. The retractable flap deflects from the body of the vehicle or object and returns back to its original position which is uniform to the body. The retractability of the flap allows the vehicle or object to be more streamlined.

### BACKGROUND OF THE INVENTION

In the field of engineering, there are different types of flaps located on vehicles that are used to change their trajectory. They are usually referred to as ailerons, elevators, and rudders. Generally, the ailerons are located on the wings of aircrafts and the elevators and rudders are located on the tail of the aircraft or water vessels. When these flaps are adjusted accordingly, the vehicle can utilize the oncoming fluid to alter its trajectory. Even though this is useful, there is a way to get rid of the tail of these vehicles that controls the rudder and elevator and improve the performance of the vehicle.

This invention is to be applied in the field of fluid mechanics. The retractable flaps are designed to deflect when being used and retract when they are not being used on vehicles and objects. Flaps are universally defined as devices that deflect to generate lift or drag to adjust the trajectory of a vehicle or object. Drag is generated depending on the oncoming fluid and the shape of the vehicle. The current design of flaps on vehicles and objects generate more drag and do not have the ability to retract within the skin of the vehicle or object after changing the vehicle's trajectory. Skin is defined as the outer layer of a vehicle or object. The ability to hide or retract the flaps along the skin of the vehicle and object decreases turbulence and drag.

### BRIEF SUMMARY OF THE INVENTION

The retractable flaps are made along the skin of a vehicle or object. The initial position of the flaps is uniform with the skin. When the flaps are being used, they deflect and come out of the skin to generate the desired drag to adjust the trajectory. When the flaps are not being used, they retract and become even with the skin again. The retractability of the flaps minimizes drag.

### BRIEF DESCRIPTION OF THE DRAWINGS

FIG. 1A-FIG. 1A displays the front view of the aircraft. FIG. 1A has two retractable flaps denoted as numbers 1 and 2. The number 1 pointing to the surface of the aircraft denotes a retractable flap that is not being used, not deflected, and uniform to the main body of the aircraft. The retractable flap denoted as number 2 illustrates an example of a retractable flap being used, deflected, and not uniform to the main body of the aircraft.

FIG. 1B-FIG. 1B displays the top view of the aircraft. FIG. 1B displays two retractable flaps denoted as the numbers 3 and 4. The retractable flap denoted as number 3 is not being used, not deflected, and uniform to the main body of the aircraft. This retractable flap is the top view of the retractable flap denoted as number 1 in FIG. 1A. The retractable flap denoted as number 4 is being used, deflected, and not uniform to the main body of the aircraft. This retractable flap is the top view of the retractable flap denoted as number 2 in FIG. 1A. The number 5 is pointing to a lever that controls the angle of deflection of the flap. This lever enables the retractability of the flap. The number 6 pointing to the black area that surrounds the lever and stops at the used retractable flap denotes the inside of the aircraft from which the lever came from. The curve line with two slanted lines intersecting its middle on the left wing or left side of the FIGURE denotes the end point of interest of the aircraft.

FIG. 1C-FIG. 1C displays the side view of the aircraft. FIG. 1C displays the number 7 pointing to a retractable flap. This retractable flap is the side view of the retractable flap denoted as number 2 in FIG. 1A. The number 8 is pointing to a lever that controls the angle of deflection of the flap. This lever is the side view of the lever denoted as number 5 in FIG. 1B.

### DETAILED DESCRIPTION OF THE INVENTION

The terminology within this section is used for describing the characteristics, functionality, and uses thereof. The term “and/or” used within a sentence denotes any and all combinations of one or more of the associated listed elements. The singular forms of “a,” “an,” and “the” are also intended to include the plural forms unless otherwise stated. It is presumed that scientific, technical, engineering, and mathematical terms are universally defined. It is further understood that these definitions are not limited to their common definitions and may be found through the use of dictionaries or other sources.

In travel, an object of interest encounters fluid along its body. Fluid is defined as, but not limited to, any gas, liquid, or plasma. Vehicles such as aircrafts and watercrafts can use this fluid to alter their trajectory by the use of flaps. A flap is defined as, but not limited to, any device that deflects to generate lift or drag to adjust the trajectory of a vehicle or object. When the vehicle or object deflect their flaps accordingly, the flaps generate drag by making contact with the oncoming fluid, and the fluid pushes against these flaps to turn the vehicle or object. Sometimes, these flaps may not be used for turning, but also for braking. For example purposes, aircrafts have vertical and horizontal tails that have flaps referred to as rudders and elevators. When the rudder deflects, the airplane turns either left or right depending on how it deflects. When the elevator deflects, the aircraft pitch level is adjusted to go up or down depending on how it deflects. If the pilot uses a different combination of deflecting the elevator and rudder, it can adjust the trajectory of the aircraft in different ways. Generally, these tails and flaps are useful, but when they are not being used, they generate unnecessary drag.

Drag is the opposing force operating on the surface of a vehicle or object while it is in travel. The retractable flaps are designed to operate in the same functionality of the original flaps, but they reduce drag by making a vehicle or object more streamlined. The word “original” refers to the older design of flaps and their incapability to retract after adjusting the trajectory. Retractability describes the capability of a flap to deflect from a surface and return to its original position which is uniform to the body of an object or vehicle. The original flaps are not designed in this fashion because they are attached by hinges at the back of a wing or a tail that deflect accordingly. The original flaps do not deflect from a surface, but deflect from behind a different part of an aircraft. Any other original flaps that are designed similarly to the retractable flaps are being used differently. The retractable flaps are used specifically for steering and adjusting the trajectory of a vehicle or object while returning back to uniformity. This is specified because some flaps with similar configurations are used for adjusting a wing shape to produce different lift to drag ratios and some flaps are used for braking or slowing down.

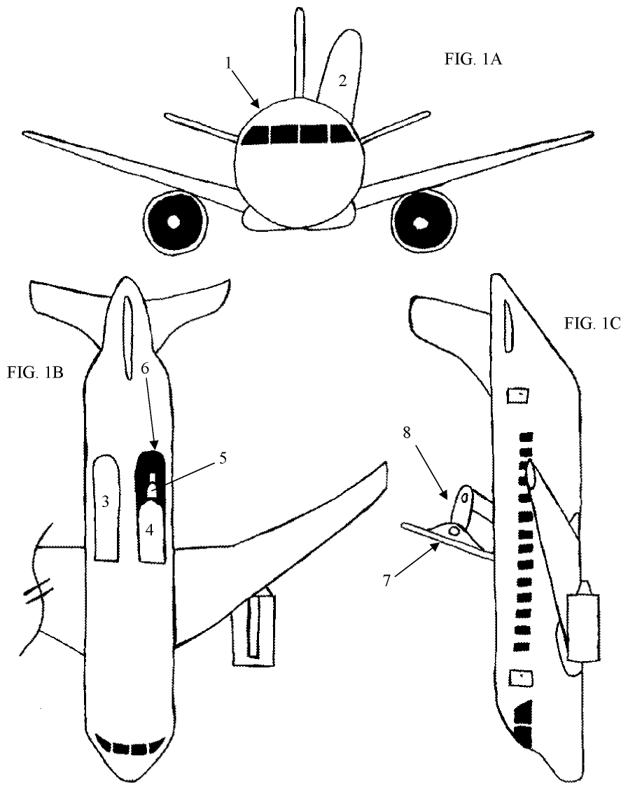

FIGS. 1A, 1B, and 1C show examples of the retractable flaps being used on an aircraft. It is presumed that these figures do not limit the scope or usefulness of the invention. For example, there can be more or less than two flaps at different locations with different shapes or configurations, and on different vehicles or objects. It is also presumed that when referring to the retractable flaps “not being used” or “being used” refers to the flaps' functionality in adjusting the trajectory of the vehicle by the use of oncoming fluid. It is further understood that this invention is not based on the retracting configuration, but the ability to retract after being used. There are different retractable configurations, and these figures display only one example for understanding and observation purposes.

FIG. 1A shows the front view of the aircraft with the numbers 1 and 2 denoting as retractable flaps. The number 1 pointing to the surface of the aircraft denotes a retractable flap that is not being used, not deflected, and uniform to the main body of the aircraft. When this retractable flap is being used, it takes on a similar orientation of the retractable flap denoted as number 2 but relative to its location. The retractable flap denoted as number 2 illustrates an example of a retractable flap being used, deflected, and not uniform to the main body of the aircraft. When the retractable flap denoted as number 2 is finished being used, it returns back to its original position and takes on a similar orientation of the retractable flap denoted as number 1 but relative to its location.

FIG. 1B displays the top view of the aircraft. FIG. 1B displays two retractable flaps denoted as the numbers 3 and 4. The retractable flap denoted as number 3 is not being used, not deflected, and uniform to the main body of the aircraft. This retractable flap is the top view of the retractable flap denoted as number 1 in FIG. 1A. The retractable flap denoted as number 4 is being used, deflected, and not uniform to the main body of the aircraft. This retractable flap is the top view of the retractable flap denoted as number 2 in FIG. 1A. The number 5 is pointing to a lever that controls the angle of deflection of the flap. This lever enables the retractability of the flap. The number 6 pointing to the black area that surrounds the lever and stops at the retractable flap denotes the inside of the aircraft from which the lever came from. The curved line with two slanted lines intersecting its middle on the left wing or left side of the FIGURE denotes the end point of interest of the aircraft.

FIG. 1C displays the side view of the aircraft. FIG. 1C displays the number 7 pointing to a retractable flap. This retractable flap is the side view of the retractable flap denoted as number 2 in FIG. 1A. The number 8 is pointing to a lever that controls the angle of deflection of the flap. This lever is the side view of the lever denoted as number 5 in FIG. 1B.

There are multiple types of vehicles and objects that can utilize this invention such as: an aircraft, spacecraft, watercraft, propelled object, and projectile object. The following definitions of an aircraft, spacecraft, watercraft, propelled object, and projectile object are simply defined, and are not limited to these definitions. An aircraft is any vehicle made to fly within the Earth's atmosphere. A spacecraft is any vehicle made to exit the Earth's atmosphere. A watercraft is any vehicle made to travel through or under water. A propelled object is any object that has a propulsion system to propel the object in a designated direction. A projectile object is any object that has the capability of being launched from a person's hand or a platform. It is presumed that the processes, manufacturability, and assembly of the retractable flaps should follow the same or similar guidelines in how the original flaps for vehicles and objects are made.

The claimed invention is:

1. Aircraft, spacecraft, and watercraft related vehicle(s) or propelled/projectile object(s) comprising of flap(s) with the ability to retract after altering trajectory, as defined in the detailed description.
